(19) United States
(12) Patent Application Publication
(10) Pub. No.: US 2016/0031393 A1
(43) Pub. Date: Feb. 4, 2016

(54) WIRE HARNESS

(71) Applicant: Yazaki Corporation, Tokyo (JP)

(72) Inventors: Tatsuya OGA, Makinohara-shi (JP); Hideomi ADACHI, Makinohara-shi (JP)

(73) Assignee: Yazaki Corporation, Tokyo (JP)

(21) Appl. No.: 14/812,540

(22) Filed: Jul. 29, 2015

(30) Foreign Application Priority Data
Jul. 30, 2014 (JP) 2014-154549

(51) Int. Cl. B60R 16/02

(52) U.S. Cl. CPC B60R 16/0215

(57) ABSTRACT

A wire harness includes at least one of electrical pathways. The electrical pathway includes a first electrical pathway, a second electrical pathway and an electrical pathway connecting part that connects the first electrical pathway and the second electrical pathway. The first electrical pathway has a flexure resistance that is higher than that of the second electrical pathway.

### CROSS-REFERENCE TO RELATED APPLICATIONS

This application claims the benefit of Japanese Patent Applications No. 2014-154549 (filed on Jul. 30, 2014), the contents of which are incorporated herein by reference.

### BACKGROUND

1. Technical Field

The present invention relates to a wire harness which includes one or a plurality of electrical pathways.

2. Related Art

A traditional wire harness for electrically connecting high voltage devices that are carried in a hybrid vehicle or an electric vehicle which, for example, is disclosed in JP-A-2014-042443 is known.

The wire harness includes a plurality of electrical pathways, an exterior member which accommodates and protects the plurality of electrical pathways, an external connecting portion which is disposed at a harness terminal and connects an external high voltage device, and a plurality of fixing members to attach and fix the wire harness to a fixing target.

In the above traditional wire harness, because it is feared that vibration might be transmitted through the external high voltage device, expensive electrical pathways which have flexure resistance entirely are used from one harness terminal until the other harness terminal.

The present invention is made in view of the above situations, and the object of the present invention is to provide a wire harness wiring structure which makes it possible to reduce the cost.

### SUMMARY

(1) According to an aspect of the invention, a wire harness includes at least one of electrical pathways, wherein the electrical pathway includes a first electrical pathway, a second electrical pathway, and an electrical pathway connecting part that connects the first electrical pathway and the second electrical pathway. The first electrical pathway has a flexure resistance that is higher than that of the second electrical pathway.

(2) In the wire harness according to (1), the first electrical pathway is disposed between an external connecting portion which is disposed at a harness terminal and performs connection with an external electrical connecting counterpart, and a fixing member, among a plurality of fixing members which are provided to attach and fix the wire harness to a fixing target, that is nearest to the external connecting portion.

(3) In the wire harness according to (2), the fixing member that is nearest to the external connecting portion includes the electrical pathway connecting part.

(4) In the wire harness according to (1), (2) or (3), the electrical pathway connecting part not only becomes the connecting portion where the first electrical pathway and the second electrical pathway are connected, but also becomes a branched portion where a third electrical pathway is branched from the electrical pathways.

(5) In the wire harness according to (1), (2), (3) or (4), the electrical pathway is a high voltage electrical pathway, is wired under a vehicle floor, and is electrically connected to an apparatus from which vibration is transmitted to the wire harness.

According to the present invention that has the above features, the wire harness includes one or a plurality of electrical pathways, and the electrical pathway not entirely but partially has high flexure resistance. That is, only the necessary part of the electrical pathway has high flexure resistance but the remaining part corresponds to an inexpensive part.

According to the present invention recorded in (1), because the electrical pathway of the wire harness includes the first electrical pathway, the second electrical pathway and the electrical pathway connecting part that connects the first electrical pathway and the second electrical pathway, and the first electrical pathway has a flexure to resistance that is higher than that of the second electrical pathway, it is possible that the electrical pathway partially has high flexure resistance. Therefore, according to the present invention, because inexpensive parts increase as compared to the traditional electrical pathway which entirely has high flexure resistance, an effect that the cost can be reduced is played.

According to the present invention recorded in (2), because the wire harness includes an external connecting portion and a plurality of fixing member besides the electrical pathways, and has high flexure resistance from the external connecting portion until a fixing member that is nearest to the external connecting portion due to the arrangement of the first electrical pathway, it is possible to have an expensive part in a relatively short range and have an inexpensive part in the rest range. Therefore, according to the present invention, an effect of reducing the cost can be played.

According to the present invention recorded in (3), the following effect is played in addition to the effects of (2). That is, an effect is played that the fixing member that is nearest to the external connecting portion can function as the electrical pathway connecting part.

According to the present invention recorded in (4), the electrical pathway can be so constructed that the third electrical pathway is branched from the electrical pathway connecting part which is the connecting portion where the first electrical pathway and the second electrical pathway are connected. Therefore, according to the present invention, an effect is played that it is possible that only the necessary part has high flexure resistance and it is possible to branch the third electrical pathway.

According to the present invention recorded in (5), an effect is played that the cost of the wire harness which is a high voltage one and is wired through the vehicle floor can be reduced.

### BRIEF DESCRIPTION OF THE DRAWINGS

FIGS. 1A, 1B are figures related to a wire harness of the present invention, in which FIG. 1A is a schematic view which indicates that the wire harness is wired, and FIG. 1B is a schematic view which indicates enlarged features of FIG. 1A (Embodiment 1).

FIG. 2 is a schematic view which indicates the constitution of the wire harness of FIG. 1 (Embodiment 1).

FIGS. 3A, 3B are cross-sectional views of the wire harness of FIG. 2, in which FIG. 3A is an A-A line sectional view of FIG. 2, and FIG. 3B is a B-B line sectional view of FIG. 2 (Embodiment 1).

FIG. 4 is an exploded perspective view which indicates an example (joint) of the electrical pathway connecting part of FIG. 2 (Embodiment 1).

FIGS. 5A, 5B are figures which indicate an example of the electrical pathway connecting part of FIG. 2, in which FIG. 5A is a perspective view which indicates a joining example, and FIG. 5B is a schematic view which indicates a connector example (Embodiment 1).

FIG. 6 is an exploded perspective view which indicates an example (terminal stand) of the electrical pathway connecting part of FIG. 2 (Embodiment 1).

FIG. 7 is a schematic view which indicates the wiring and constitution of a wire harness of another example (Embodiment 2).

FIGS. 8A and 8B are schematic views which indicate the wiring and constitution of a wire harness of another example (Embodiment 3).

FIG. 9A to 9C are schematic views which indicate the wiring and constitution of a wire harness of another example (Embodiment 4).

### DETAILED DESCRIPTION

The wire harness includes one or a plurality of electrical pathways. The electrical pathway does not entirely but partially have high flexure resistance. That is, only the necessary part of the electrical pathway has high flexure resistance but the remaining part corresponds to an inexpensive part.

### Embodiment 1

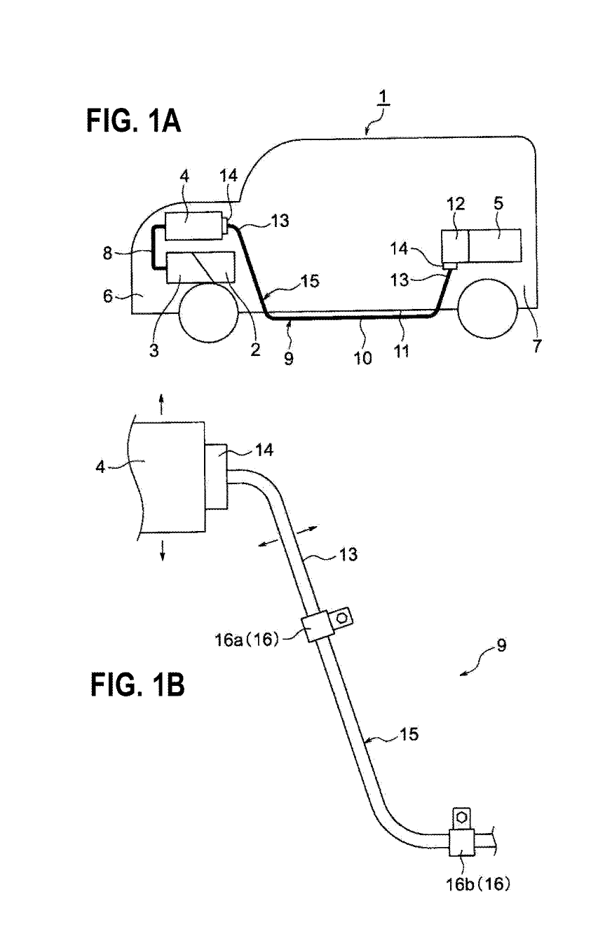

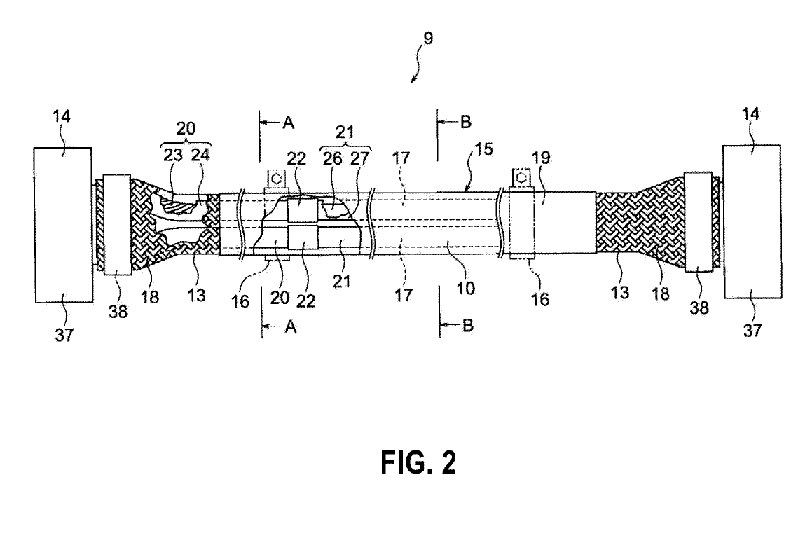

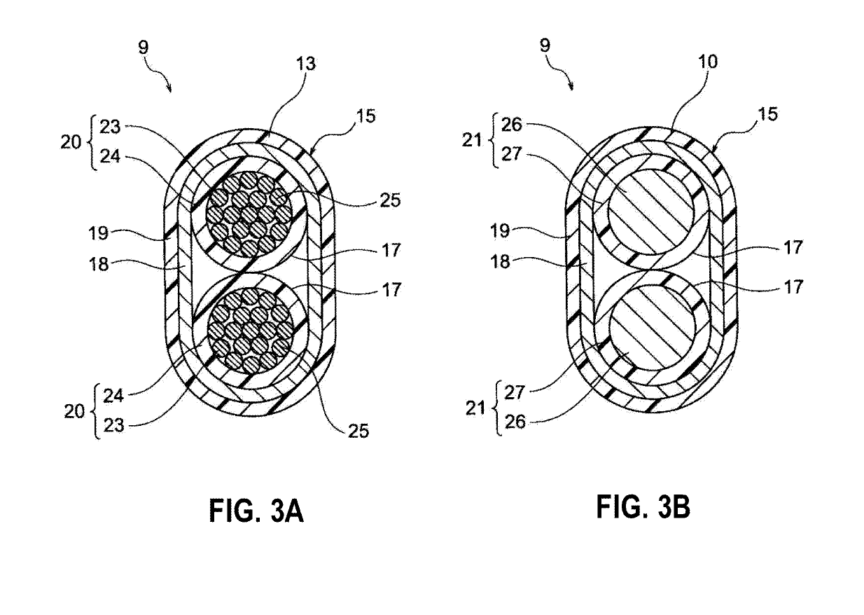

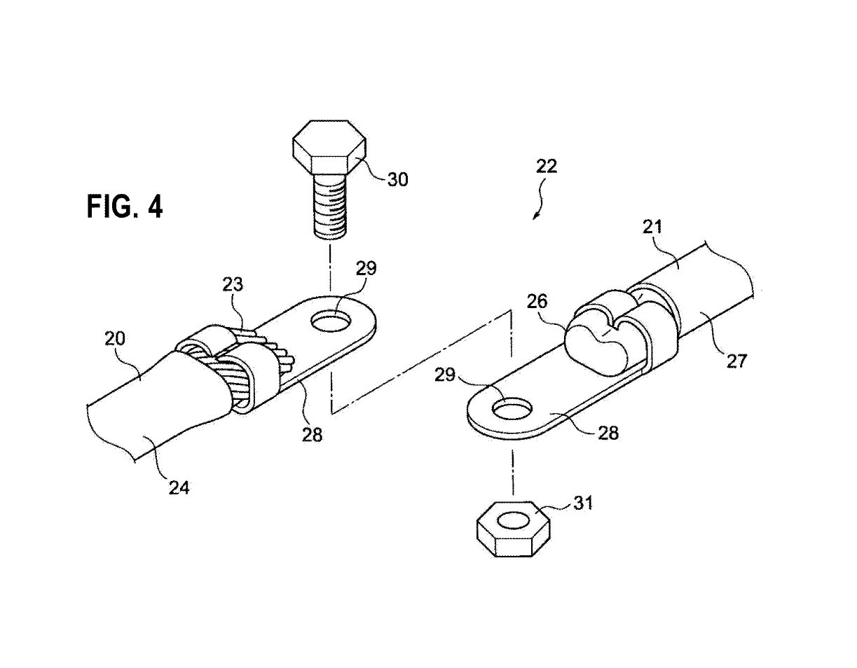

An embodiment 1 is described with reference to the figures as follows. FIGS. 1A and 1B include figures related to a wire harness of the present invention, in which FIG. 1A is a schematic view which indicates that the wire harness is wired, and FIG. 1B is a schematic view which indicates enlarged features of FIG. 1A. FIG. 2 is a schematic view which indicates the constitution of the wire harness of FIG. 1. FIGS. 3A and 3B include cross-sectional views of the wire harness of FIG. 2. FIGS. 4 to 6 are figures which indicate examples of the electrical pathway connecting part of FIG. 2. In the embodiment, the present invention is applied to a wire harness which is wired in a hybrid vehicle (or an electric vehicle or the like).

In FIG. 1A, a reference sign 1 indicates a hybrid vehicle. The hybrid vehicle 1 is a vehicle which is driven by mixing two powers of an engine 2 and a motor unit 3, and the electric power from a battery 5 (battery pack) will be supplied to the motor unit 3 via an inverter unit 4. The engine 2, the motor unit 3 and the inverter unit 4 are carried in an engine room 6 at the position of front wheels and the like in the embodiment. The battery 5 is carried in a vehicle rear part 7 of rear wheels and the like (the battery 5 may be carried in an indoor space behind the engine room 6).

The motor unit 3 and the inverter unit 4 are connected by a high voltage (for high voltage) wire harness 8. The battery 5 and the inverter unit 4 are also connected by a high voltage wire harness 9. A middle part 10 of the wire harness 9 is wired below a vehicle floor 11. The wire harness 9 is wired substantially in parallel with the vehicle floor 11. The vehicle floor 11 is a well-known body and is a so-called panel member, and through holes are formed at predetermined positions. The wire harness 9 is inserted through these through holes watertightly.

The wire harness 9 and the battery 5 are connected through a junction block 12 which the battery 5 is provided with. An external connecting portion such as a shielding connector 14 which is disposed at a harness terminal 13 of the wire harness 9 at the rear end side is electrically connected to the junction block 12. Further, the wire harness 9 and the inverter unit 4 are electrically connected through an external connecting portion such as a shielding connector 14 which is disposed at a harness terminal 13 of the wire harness 9 at the front end side.

The motor unit 3 includes a motor and a generator. The inverter unit 4 includes an inverter and a converter in construction. The motor unit 3 is formed as a motor assembly including a shielding case. The inverter unit 4 also is formed as an inverter assembly including a shielding case. The battery 5 is a Ni—MH battery or Li-ion battery, and is modularized. An electricity accumulating device such as a capacitor may be used. Of course, the battery 5 should not be particularly limited as long as the battery 5 may be used for the hybrid vehicle 1 or an electric vehicle.

The long wire harness 9 which is wired through the vehicle floor 11 includes a harness body 15, and the shielding connectors 14 which are disposed as external connecting portion at two ends of the harness body 15, that is, the harness terminals 13. The wire harness 9 further includes a plurality of fixing members 16 (for example, clamps) for wiring at predetermined positions, and a waterproofing member (for example, a grommet) not shown. p First, when features of the above wire harness 9 are briefly described, the wire harness 9 is connected to the inverter unit 4, as shown in FIG. 1B. Therefore, vibration from the side of the inverter unit 4 (for example, from the engine 2) is transmitted to the wire harness 9 while the vehicle is running (the arrows of the figure indicate the vibration). When the vibration is transmitted to the wire harness 9, a range of fixing points that are nearest to the shielding connector 14, namely until a fixing member 16a, becomes easy to be affected by the vibration particularly. Thus, the wire harness 9 adopts an electrical pathway that is constructed of a part having high flexure resistance from the shielding connector 14 until the fixing member 16a. If such a wire harness 9 is used, only a necessary part has high flexure resistance, and the remaining part can correspond to an inexpensive part. Therefore, compared with that the whole of the electrical pathway has high flexure resistance, the cost can be reduced remarkably. The present invention is not limited to the range until the fixing member 16a, but may be applied to a range, for example, until a fixing member 16b in the figure.

Next, the above constitution of the wire harness 9 is described with reference to FIG. 2 to FIG. 6.

In FIG. 2, the harness body 15 includes a plurality of (two in this embodiment, as an example) electrical pathways 17, a shielding member 18 which collectively covers the plurality of electrical pathways 17, and a protective member 19 which is provided outside the shielding member 18. The harness body 15 is characterized in the constitution of the electrical pathways 17 and the arrangement of the constitution.

As shown in FIGS. 2 and 3, the electrical pathway 17 includes a first electrical pathway 20, a second electrical pathway 21, and an electrical pathway connecting part 22. The first electrical pathway 20 of the electrical pathway 17 of the present embodiment is disposed at the side to connect with the inverter unit 4 which is an outside electrical connecting counterpart. That is, the first electrical pathway 20 is disposed in accordance with the position of the position of the harness terminal 13 at the front side. The first electrical pathway 20 has a flexure resistance that is higher than that of the second electrical pathway 21 (The flexure resistance is such a characteristic that outbreak of trouble is hard to happen even if flexure is repeated. The flexure resistance may be read as vibration resistance in the present invention).

The first electrical pathway 20 includes a conductive conductor 23 and an insulative insulator 24 which covers the conductive conductor 23. The first electrical pathway 20 has high flexure resistance as described above. The conductor 23 is manufactured of copper, copper alloy, aluminum or aluminum alloy. In the embodiment, an aluminum conductor which has merits of being inexpensive and lightweight is adopted (an example). In the conductor 23, a conductor structure that a predetermined number of strands 25 are twisted into a circular cross section form is adopted (which is an example. If such a conductor structure is used, flexibility can be kept. Vibration can be absorbed if the flexibility can be kept, and the conductor structure is effective for the above flexure resistance.)

The insulator 24 is formed as a circular cross section-formed coating by extruding thermoplastic resin material around the outer peripheral surface of the conductor 23. The insulator 24 is formed with a predetermined thickness. Various types of well-known thermoplastic resin can be used as the above thermoplastic resin, and for example, polymer materials such as polyvinyl chloride resin, polyethylene resin and the polypropylene resin are appropriately selected.

The second electrical pathway 21 is more inexpensive than the first electrical pathway 20, and has a flexure resistance lower than that of the first electrical pathway 20. The second electrical pathway 21 includes a conductive conductor 26, and an insulative insulator 27 which covers the conductive conductor 26. The conductor 26 is manufactured of copper, copper alloy, aluminum or aluminum alloy. In the embodiment, an aluminum conductor which has merits of being inexpensive and lightweight is adopted (as an example). The conductor structure of the conductor 26 is chosen appropriately. The insulator 27 is formed by extruding thermoplastic resin material around the outer peripheral surface of the conductor 26. The insulator 27 is formed of the same material and the same thickness as those of the insulator 24 of the first electrical pathway 20 in the embodiment.

The electrical pathway connecting part 22 is a part which connects the first electrical pathway 20 and the second electrical pathway 21, and the electrical pathway connecting part 22 is formed to become insulative from outside. Four specific inside structure examples of the electrical pathway connecting part 22 are described with reference to FIGS. 4 to 6 as follows.

In FIG. 4, a terminal of the first electrical pathway 20 is provided with a conductive terminal metal fitting 28. The terminal metal fitting 28 is tightened and connected to the conductor 23 of the first electrical pathway 20. The terminal metal fitting 28 is a well known one, and has an electrical contact part where a bolt insertion through hole 29 is formed. On the other hand, a terminal (conductor 26) of the second electrical pathway 21 is provided with the same terminal metal fitting 28 as above.

When the terminal metal fittings 28 of the first electrical pathway 20 and the second electrical pathway 21 are overlapped, and a bolt 30 is inserted into the bolt insertion through hole 29 and fastened and fixed with a nut 31, electrical connection is completed. Then, when an insulative member (covered with tape winding or a heat shrinkable tube) not shown is provided outside the connection part, the electrical pathway connecting part 22 is formed.

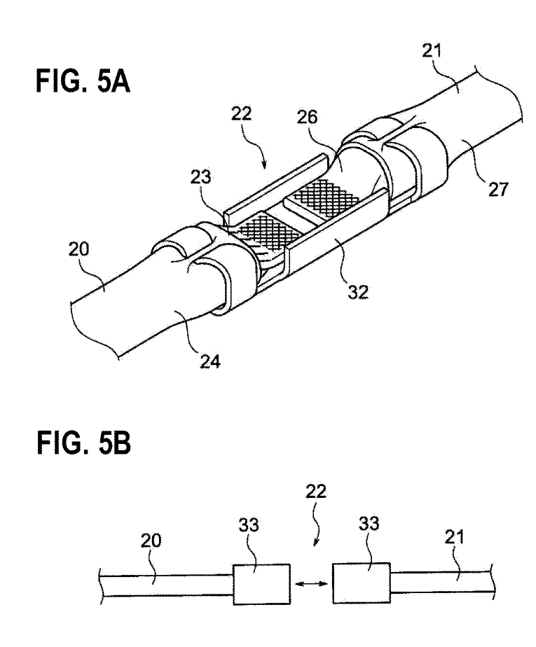

In FIG. 5A, the conductor 23 exposed at a terminal of the first electrical pathway 20 is joined to one end side of a conductive joint terminal 32. Further, the conductor 26 exposed at a terminal of the second electrical pathway 21 is also joined to the other end side of the joint terminal 32. The joining may be performed with well-known joining methods such as supersonic wave joining (including welding, fusing, cold-welding, pop riveting, soldering and the like).

When the conductors 23, 26 of the first electrical pathway 20 and the second electrical pathway 21 are joined to the joint terminal 32, respectively, electrical connection is completed. Then, when an insulative member (covered with tape winding or a heat shrinkable tube) not shown is provided outside the joining part, the electrical pathway connecting part 22 is formed.

In FIG. 5B, well-known connectors 33 are provided at the terminals of the first electrical pathway 20 and the second electrical pathway 21. In this case of the electrical pathway connecting part 22, electrical connection is completed by simply making the connectors 33 engaged. In the case of FIG. 5B, it is not necessary to provide insulative members outside like other examples.

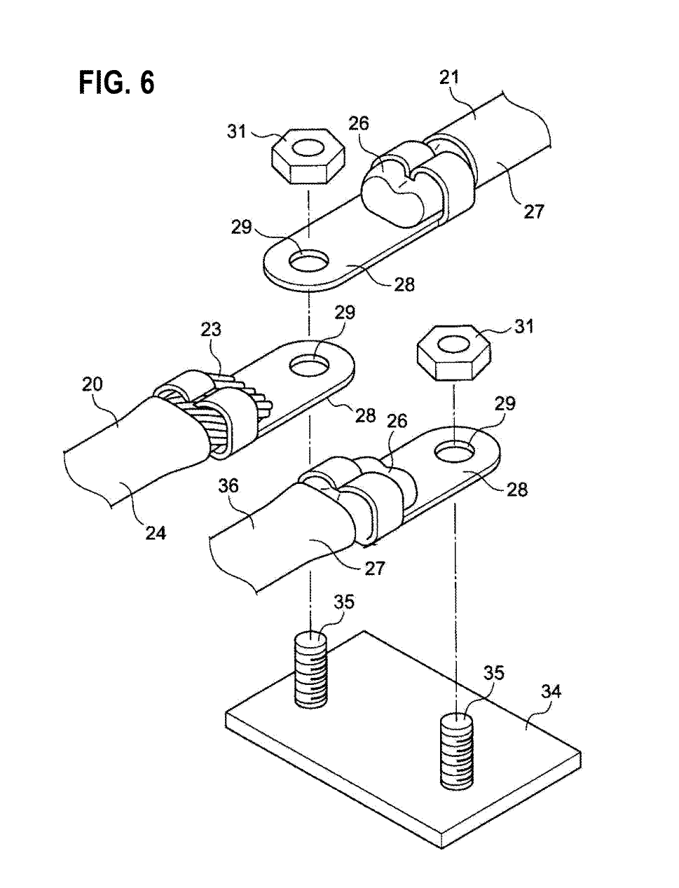

In FIG. 6, a terminal of the first electrical pathway 20 is provided with a conductive terminal metal fitting 28. The terminal metal fitting 28 is tightened and connected to the conductor 23 of the first electrical pathway 20. On the other hand, a terminal (conductor 26) of the second electrical pathway 21 is provided with the same terminal metal fitting 28 as above. A reference sign 34 in FIG. 6 indicates a terminal stand. The terminal stand 34 is provided with two stud bolts 35 (the number of the stud bolts 35 is an example).

When the terminal metal fittings 28 of the first electrical pathway 20 and the second electrical pathway 21 are overlapped, and one of the stud bolts 35 is inserted into the bolt insertion through hole 29 and fastened and fixed with a nut 31, electrical connection is completed. Then, when an insulative member (covered with tape winding or a heat shrinkable tube) not shown is provided outside the connection part, the electrical pathway connecting part 22 is formed. A third electrical pathway 36 may be branched by using the other of the stud bolts 35. The electrical pathway connecting part 22 of FIG. 6 has a branched part of the third electrical pathway 36 that is branched from the electrical pathway 17 in addition to the connecting part of the first electrical pathway 20 and the second electrical pathway 21.

Of course, the electrical pathway connecting part 22 is not limited to the above examples as long as the electrical pathway connecting part 22 can connect the first electrical pathway 20 and the second electrical pathway 21.

When the first electrical pathway 20 and the second electrical pathway 21 are connected by the electrical pathway connecting part 22, one electrical pathway 17 is formed.

In FIGS. 2 and 3, the shielding member 18 is included to have an electromagnetic shielding function in the wire harness 9. The shielding member 18 is formed as a member which can collectively cover the two electrical pathways 17 which are in a side-by-side state. The shielding member 18 is formed of a web or a metal foil that has conductivity. In the embodiment, a shielding member formed of web is adopted. The web of the shielding member 18 is formed by weaving extra-fine strands into a tubular shape.

If the above metal foil is adopted, the shielding member 18 may be formed into such a shape to wind around the outside of the two electrical pathways 17. The terminals of the shielding member 18 are grounded to shield shells 37 to be described below of the shielding connectors 14. The shielding member 18 has flexibility.

The protective member 19 is included to protect the harness body 15 from outside. The protective member 19 is formed at a predetermined thickness, for example, by a heat shrinkable tube, or by extruding thermoplastic resin material, or by winding a sheet member made of resin. The protective member 19 is arranged and formed at least in a range where protection from outside is necessary. An exterior member that is disclosed in JP-A-2014-042443 given in the related art part may be adopted as the protective member 19.

In FIG. 2, the shielding connectors 14 which are respectively disposed at the terminals (harness terminals 13) of the above harness body 15 include conductive metal fittings (not shown), insulating housings (not shown), conductive shield shells 37, and metal fastening rings 38.

The above terminal metal fittings are provided at the terminals of the electrical pathways 17. The terminal metal fittings are accommodated and held, for example, in the above housings. The shield shells 37 are metal members provided outside the housings, have fixing parts (not shown), and are assembled to shielding cases of the inverter unit 4 or the junction block 12 (refer to FIG. IA) through the fixing parts. The shield shells 37 have cylindrical portions which the terminals of the shielding member 18 are covered with. The fastening rings 38 are provided to ground the terminals of the shielding member 18 to the above cylindrical portions of the shield shells 37. The fastening rings 38 are fastened and fixed.

For the above constitution and structure, when the shielding connectors 14 are assembled to the terminals of the harness body 15 (harness terminals 13) after the harness body 15 is manufactured, the manufacture of the wire harness 9 is completed. The wire harness 9 is wired to the vehicle by using the same method as traditional embodiments.

As described above with reference to FIGS. 1 to 6, because the wire harness 9 is constructed by including the electrical pathway 17 that includes the first electrical pathway 20, the second electrical pathway 21 and the electrical pathway connecting part 22 that connects the first electrical pathway 20 and the second electrical pathway 21, and the first electrical pathway 20 has a flexure resistance that is higher than that of the second electrical pathway 21, the electrical pathway 17 of the above constitution partially has high flexure resistance. Therefore, because inexpensive parts increase as compared to the traditional electrical pathway which entirely has high flexure resistance, an effect that the cost of the wire harness 9 can be reduced is played.

### Embodiment 2

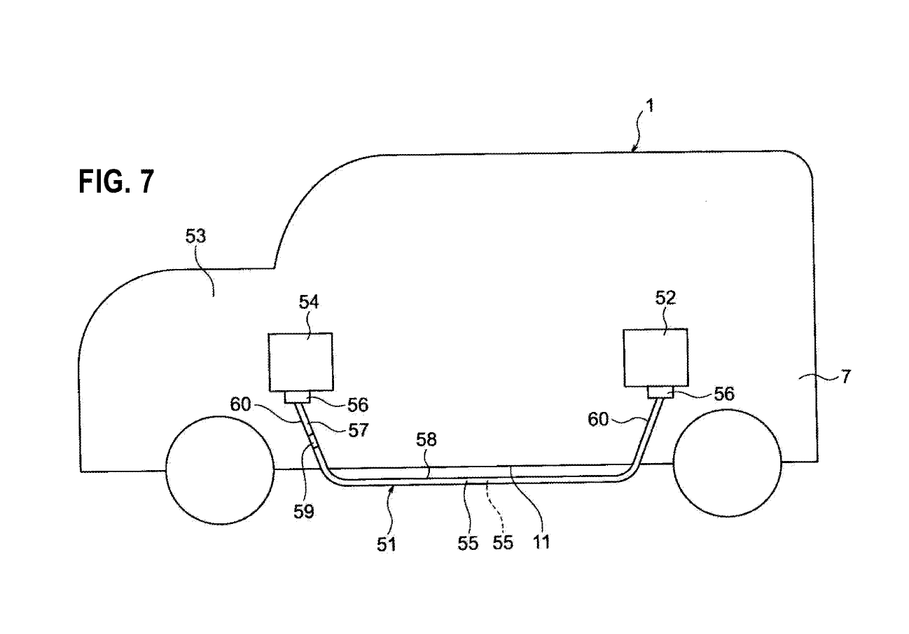

An embodiment 2 is described with reference to the figures as follows. FIG. 7 is a schematic view which indicates the wiring and constitution of a wire harness of another example.

In FIG. 7, a reference sign 51 shows a wire harness. The wire harness 51 is a low voltage (for low voltage) one, and is included to electrically connect, for example, a low voltage battery 52 at the vehicle rear part 7 of the hybrid vehicle 1 and a supplementary device 54 (apparatus) loaded in a vehicle front part 53.

The wire harness 51 is wired through the vehicle floor 11 in this embodiment (as an example, it is also possible to be wired through the vehicle compartment sides). The wire harness 51 includes two electrical pathways 55, 55 which are in a side-by-side state, connectors 56, 56 which are provided at the terminals of the electrical pathways 55, 55, and a plurality of fixing members (for example, clamps) not shown, and a waterproofing member (for example, a grommet) not shown.

The electrical pathway 55 has a first electrical pathway 57, a second electrical pathway 58 and an electrical pathway connecting part 59, and is formed into a row. The material, structure and function concerning these constitutions are the same as those of the first electrical pathway 19, the second electrical pathway 20 and the electrical pathway connecting part 21 of the embodiment 1, and their description is omitted. The first electrical pathway 57 of the electrical pathway 55 is disposed at the position of a harness terminal 60 at the front end. The second electrical pathway 58 is disposed at the rest part.

As described above with reference to FIG. 7, because the wire harness 51 of the embodiment 2 is constructed to partially have high flexure resistance like the embodiment 1, an effect that the cost can be reduced is played.

Embodiment3

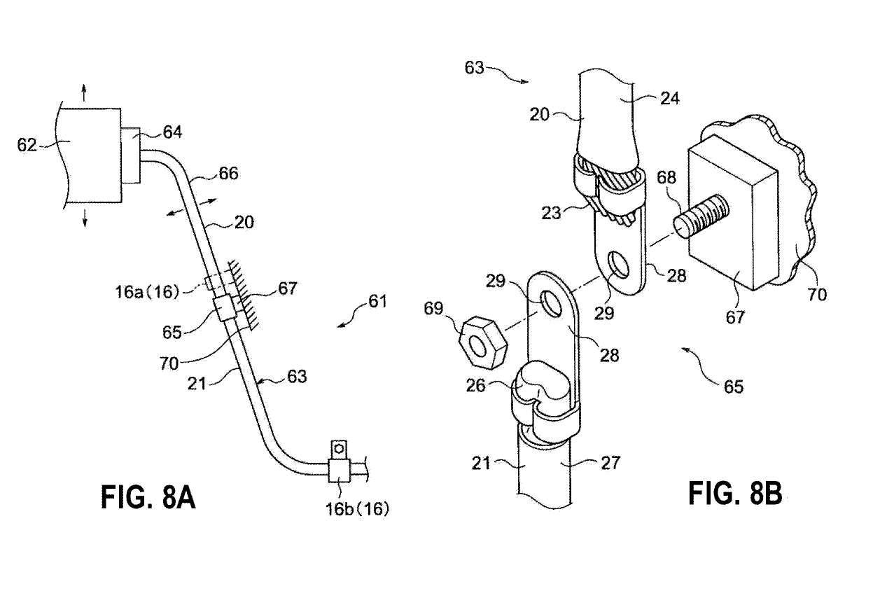

An embodiment 3 is described with reference to the figures as follows. FIGS. 8A and 8B is schematic views which indicates the wiring and constitution of a wire harness of another example. Components that are substantially identical with those in the above-mentioned embodiment 1 are given identical numbers, and their detailed description is omitted. Of course, the description content of the embodiment 3 is applicable to any of the embodiments 1 and 2.

In FIG. 8A, a reference sign 61 shows a wire harness. The wire harness 61 is included to electrically connect, for example, a supplementary device 62 (apparatus) and a battery (not shown) loaded in the vehicle. In this embodiment, the supplementary device 62 becomes a vibration transmission source relative to the wire harness 61.

The wire harness 61 includes a plurality of electrical pathways 63, a connector 64 which is provided at terminals of the electrical pathways 63, and a plurality of fixing members (for example, clamps) 16, and a waterproofing member (for example, a grommet) not shown. The electrical pathway 63 has a first electrical pathway 20, a second electrical pathway 21 and an electrical pathway connecting part 65, and is formed into a row. In the electrical pathway 63, the first electrical pathway 20 is disposed at the position of a harness terminal 66, and the second electrical pathway 21 is disposed at a position except the harness terminal 66.

The electrical pathway connecting part 65 is a part which connects the first electrical pathway 20 and the second electrical pathway 21, and has terminal metal fittings 28 which are respectively provided at a terminal of the first electrical pathway 20 and a terminal of the second electrical pathway 21. Further, the electrical pathway connecting part 65 has a terminal stand 67 to connect the terminal metal fittings 28. The terminal stand 67 is provided with a stud bolt 68, and this stud bolt 68 is inserted through the terminal metal fittings 28. The terminal metal fittings 28 which are overlapped are fixed by fastening a nut 69. The terminal stand 67 is integrally provided at a desired position of a vehicle body 70, in the embodiment. Because the terminal stand 67 integrated with the vehicle body 70 in this way is included, the electrical pathway connecting part 65 not only connects the first electrical pathway 20 and the second electrical pathway 21, but also becomes a fixing member (a fixing point that is nearest to the connector 64) of the wire harness 61. It is also possible to separately provide a fixing member 16a near the electrical pathway connecting part 65 (the side near the connector 64) and fix the fixing member 16a to the vehicle body 70. In this case, the fixing member 16a becomes a fixing point that is nearest to the connector 64.

As described above with reference to FIG. 8B, because the wire harness 61 of the embodiment 3 is constructed to partially have high flexure resistance like the embodiment 1, an effect that the cost can be reduced is played. Further, according to the wire harness 61 of the embodiment 3, an effect is played that the electrical pathway connecting part 65 which is different from those in FIGS. 4 to 6 can be provided.

### Embodiment 4

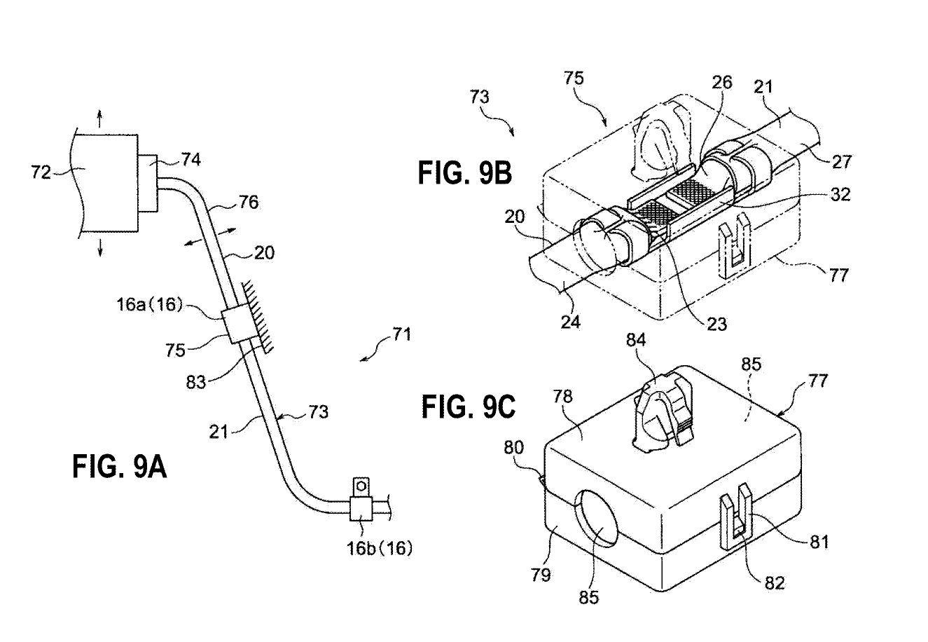

An embodiment 4 is described with reference to the figures as follows. FIGS. 9A to 9C are schematic views which indicate the wiring and constitution of a wire harness of another example. Components that are substantially identical with those in the above-mentioned embodiment 1 are given identical numbers, and their detailed description is omitted. Of course, the description content of the embodiment 4 is applicable to any of the embodiments 1 and 2.

In FIG. 9A, a reference sign 71 shows a wire harness. The wire harness 71 is included to electrically connect, for example, a supplementary device 72 (apparatus) and a battery (not shown) loaded in the vehicle. In this embodiment, the supplementary device 72 becomes a vibration transmission source relative to the wire harness 71.

The wire harness 71 includes a plurality of electrical pathways 73, a connector 74 which is provided at terminals of the electrical pathways 73, and a plurality of fixing members (for example, clamps) 16, and a waterproofing member (for example, a grommet) not shown. The electrical pathway 73 has a first electrical pathway 20, a second electrical pathway 21 and an electrical pathway connecting part 75, and is formed into a row. In the electrical pathway 73, the first electrical pathway 20 is disposed at the position of a harness terminal 76, and the second electrical pathway 21 is disposed at a position except the harness terminal 76.

The electrical pathway connecting part 75 is a part which connects the first electrical pathway 20 and the second electrical pathway 21. As shown in FIG. 9B and 9C, the electrical pathway connecting part 75 includes a joint terminal 32 and a protector 77. The joint terminal 32 is provided to join a terminal of the first electrical pathway 20 and a terminal of the second electrical pathway 21, respectively. The protector 77 is provided as a member which covers the joining part to become insulative from outside. The protector 77 is also provided as a fixing member (a fixing point that is nearest to the connector 64) for wiring the wire harness 71. The protector 77 is described more in detail as follows.

The protector 77 is a resin molded article that has insulativity, and has an upper cover 78 and a lower cover 79. The upper cover 78 and the lower cover 79 are connected by a hinge 80. The upper cover 78 and the lower cover 79 are formed into an overlapped shape when the hinge 80 is rotated around a shaft. When the upper cover 78 and the lower cover 79 are overlapped, a locking frame 81 (locking part) of the upper cover 78 and a locking claw 82 (locking part) of the lower cover 79 are formed into such a shape that the locking frame 81 and the locking claw 82 are mutually hooked.

The upper cover 78 is formed with a clip part 84 which is inserted into an engaging hole (not shown) of a vehicle body panel 83 to be engaged with the fringe of the engaging hole. Further, the upper cover 78 is formed with electrical pathway drawing outlets 85 as parts where the electrical pathways 73 are drawn out. The clip part 84 is one example, and other fixing parts may be adopted. Specifically, an example includes that a bracket is provided at the side of the vehicle body panel 83, and the upper cover 78 is provided with a part that is attached to the bracket.

As described above with reference to FIGS. 9A to 9C, because the wire harness 71 of the embodiment 4 is constructed to partially have high flexure resistance like the embodiment 1, an effect that the cost can be reduced is played. Further, according to the wire harness 71 of the embodiment 4, an effect is played that the electrical pathway connecting part 75 which is different from those in FIGS. 4 to 6 can be provided.

In addition, it is apparent that various modifications can be made to the present invention without changing the purpose of the present invention.

What is claimed is:

1. A wire harness comprising at least one of electrical pathways, wherein
the electrical pathway includes:
a first electrical pathway;
a second electrical pathway; and
an electrical pathway connecting part that connects the first electrical pathway and the second electrical pathway, and
the first electrical pathway has a flexure resistance that is higher than that of the second electrical pathway.

2. The wire harness according to claim 1, wherein
the first electrical pathway is disposed between an external connecting portion which is disposed at a harness terminal and performs connection with an external electrical connecting counterpart, and a fixing member, among a plurality of fixing members which are provided to attach and fix the wire harness to a fixing target, that is nearest to the external connecting portion.

3. The wire harness according to claim 2, wherein
the fixing member that is nearest to the external connecting portion includes the electrical pathway connecting part.

4. The wire harness according to claim 1, wherein
the electrical pathway connecting part not only becomes the connecting portion where the first electrical pathway and the second electrical pathway are connected, but also becomes a branched portion where a third electrical pathway is branched from the electrical pathways.

5. The wire harness according to claim 1, wherein
the electrical pathway is a high voltage electrical pathway, is wired under a vehicle floor, and is electrically connected to an apparatus from which vibration is transmitted to the wire harness.
